(19) United States
(12) Patent Application Publication
(10) Pub. No.: US 2014/0239799 A1
(43) Pub. Date: Aug. 28, 2014

(54) FLAT EMITTER

(71) Applicants: Jörg Freudenberger, Kalchreuth (DE); Jens Fürst, Herzogenaurach (DE); Freddy Güthlein, Effeltrich (DE); Giovanni Laporta, Fuerth (DE); Gunter Röhrich, Erlangen (DE); Matthias Seufert, Pettstadt (DE)

(72) Inventors: Jörg Freudenberger, Kalchreuth (DE); Jens Fürst, Herzogenaurach (DE); Freddy Güthlein, Effeltrich (DE); Giovanni Laporta, Fuerth (DE); Gunter Röhrich, Erlangen (DE); Matthias Seufert, Pettstadt (DE)

(73) Assignee: SIEMENS AKTIENGESELLSCHAFT, Munich (DE)

(21) Appl. No.: 14/178,314

(22) Filed: Feb. 12, 2014

(30) Foreign Application Priority Data
Feb. 25, 2013 (DE) 102013203077.0

(51) Int. Cl. H01J 1/18

(52) U.S. Cl. CPC H01J 1/18
USPC 313/292

(57) ABSTRACT

A flat emitter is disclosed. In an embodiment, the flat emitter includes an emitter surface, which upon application of a heating voltage, emits electrons; a first end area, which has a first support rod; and a second end area, which has a second support rod. At least one first support rod has a narrow section extending in a longitudinal direction and is bonded to the first end area or a second support rod, which has a narrow section extending in a longitudinal direction and is bonded to the second end area. A flat emitter of this kind is structurally simple and offers a high level of electron emission at the same time as a longer useful life.

### PRIORITY STATEMENT

The present application hereby claims priority under 35 U.S.C. §119 to German patent application number DE 102013203077.0 filed Feb. 25, 2013, the entire contents of which are hereby incorporated herein by reference.

### FIELD

At least one embodiment of the invention generally relates to a flat emitter.

A flat emitter of at least one embodiment may serve as an electron source and may be arranged in a cathode of an X-ray tube. The electrons generated by the flat emitter are accelerated in the direction of an anode (target). Upon striking the anode the electrons are slowed down, whereupon X-ray radiation arises, which can for example be used for diagnostic imaging, for therapeutic irradiation, analytical material examination or for safety-related monitoring.

### BACKGROUND

Flat emitters with a rectangular emitter surface are for example described in DE 27 27 907 C2 and DE 10 2008 046 721 A1. Flat emitters with a circular emitter surface are known from DE 199 14 739 C1. In the case of the aforementioned flat emitters, the emitter surface and the connecting pins are embodied in one piece and brought into a 90° position via a bend. The connecting pins of the flat emitter are fixed rigidly in the cathode head. As a result of a certain inherent elasticity of the connecting pins, a limited elasticity of the suspension of the flat emitter is provided.

Further disclosed in U.S. Pat. No. 7,693,265 B2 is a flat emitter, onto the rear of which are welded rigid rod-like connecting pins (support rods).

An emitter with welded contact rods is further described in U.S. Pat. No. 6,801,599 B1, in which a certain amount of flexibility in the fixing of the emitter in the cathode head can be achieved by way of long sleeves.

The aforementioned flat emitters are in each case heated by way of resistance heating, that is by way of energization (application of heating current).

During operation of the X-ray tube, a heating voltage (resistance heating) is applied to the flat emitter, which preferably comprises tungsten, tantalum or rhenium, and is thereby heated to temperatures up to 2,600° C., whereby electrons can overcome the characteristic work function of the emitter material as a result of their thermal motion and then be available as free electrons. After their thermal emission, the electrons are accelerated to an anode by way of an electrical potential of approx. 120 kV. When the electrons reach the anode, X-ray radiation is generated in the surface of the anode.

The flat emitter is rigidly fixed in the cathode head at its two connecting pins or support rods, via which the heating current is fed.

In the flat emitter the temperatures occurring during operation lead to relatively strong linear expansions, which result in elastic and/or plastic deformations, with mechanical stresses of between 100 MPa and 200 MPa possibly occurring in the emitter due to the thermal expansion. Deformations of this kind can have a negative influence on the geometry of the emitted electron beam, as a result of which the geometry of the focal spot generated at the anode, and consequently the image quality, can deteriorate correspondingly. In addition the constant activation and deactivation of the heating current during operation of the X-ray tube results in a continuous alternate loading of the thermoionic emitter, which drastically reduces the useful life of the emitter.

In order to prevent thermally-related linear expansions of the flat emitter leading to an elastic and/or plastic deformation of the flat emitter and thus of the emitter surface, it is known from DE 10 2010 039 765 A1 to position a flat emitter in a first end area by way of a fixed bearing and to limit it to a thermal main expansion plane in a second end area by way of a floating bearing. In the case of this structurally relatively complex solution thermal linear expansions of the flat emitter thus exert no negative influence on the geometry of the emitted electron beam.

### SUMMARY

At least one embodiment of the present invention creates a structurally simple flat emitter with a longer useful life and a high level of electron emission.

According to at least one embodiment of the invention, a flat emitter is disclosed. Advantageous embodiments of the inventive flat emitter are in each case the subject of further claims.

A flat emitter of at least one embodiment comprises an emitter surface, which emits electrons upon the application of a heating voltage, a first end area, which has a first support rod, and a second end area, which has a second support rod. According to at least one embodiment of the invention, at least one first support rod or a second support rod has a narrow section extending in a longitudinal direction and is bonded to the first end area or to the second end area respectively.

### BRIEF DESCRIPTION OF THE DRAWINGS

There follows an example embodiment shown in schematic form and illustrating the invention in greater detail on the basis of the drawing, without however being restricted thereto. Wherein:

FIG. 1 shows a view, seen from below, of a flat emitter according to one embodiment and

FIG. 2 shows a detailed view of a support rod for the flat emitter shown in FIG. 1.

### DETAILED DESCRIPTION OF THE EXAMPLE EMBODIMENTS

The present invention will be further described in detail in conjunction with the accompanying drawings and embodiments. It should be understood that the particular embodiments described herein are only used to illustrate the present invention but not to limit the present invention.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

Specific structural and functional details disclosed herein are merely representative for purposes of describing example embodiments of the present invention. This invention may, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of embodiments of the present invention.

A flat emitter of at least one embodiment comprises an emitter surface, which emits electrons upon the application of a heating voltage, a first end area, which has a first support rod, and a second end area, which has a second support rod. According to at least one embodiment of the invention, at least one first support rod or a second support rod has a narrow section extending in a longitudinal direction and is bonded to the first end area or to the second end area respectively.

Bonds should be taken to mean connections in which the bonding partner—in the present case this is the support rod and end area in each case—are held together by atomic or molecular forces. In the present case these include welded connections and hard solder connections. Bonded connections cannot be released in a non-destructive manner (irreversibly releasable connections).

In that in the case of at least one embodiment of the inventive flat emitter, at least one first support rod or one second support rod has a narrow section extending in a longitudinal direction, the thermally-related linear expansions of the flat emitter do not lead to an elastic and/or plastic deformation of the emitter surface. Fissures in the emitter structure are also reliably prevented. Thermal linear expansions of the emitters thus exert no negative influence on the geometry of the emitted electron beam.

In a particularly advantageous embodiment, both the first support rod and the second support rod in each case have a narrow section extending in a longitudinal direction. The risk of elastic and/or plastic deformation of the emitter surface and the formation of fissures in the emitter structure is again reduced.

As in the case of at least one embodiment of the inventive flat emitter and in the preferred embodiment, the thermally-related linear expansions of the flat emitter are at least in part taken up via at least one of the two support rods, the constant activation and deactivation of the heating current during operation of the X-ray tube results only in a greatly reduced mechanical continuous alternate loading of the flat emitter, as a result of which the emitter's useful life is increased. An X-ray tube with at least one embodiment of the inventive flat emitter thus provides a correspondingly longer useful life.

In at least one embodiment of the inventive flat emitter and in the preferred embodiment, the thermally-related linear expansions of the flat emitter are at least in part taken up by one of the two support rods. The constant activation and deactivation of the heating current during operation of the X-ray tube thus results only in a greatly reduced mechanical continuous alternate loading of the flat emitter or the emitter surface, as a result of which the emitter's useful life is extended. An X-ray tube with at least one embodiment of the inventive flat emitter thus has a correspondingly longer useful life.

As a result of the significantly reduced mechanical load on the emitter surface even in the case of a high emitter temperature, which prevents the formation of fissures in the emitter structure, a high level of electron emission can also be guaranteed over a relatively long timescale.

Within the framework of at least one embodiment of the invention, a multiplicity of first and second support rods can also be provided for. It is thus for example possible for the first end area to have one or two first support rods and one or two second support rods to be arranged in the second end area.

In the case of the support rods concerned, the narrow sections of the respective support rods extending in a longitudinal direction can be simply adapted to the particular application. Thus in at least one embodiment of the inventive solution, for example, the narrow sections on the first support rod and the second support rod can be embodied in identical or different form.

According to one embodiment, the first support rod and the second support rod can each have a circular cross-section. According to an embodiment, the first support rod and the second support rod each have a rectangular cross-section. However within the framework of embodiments of the invention, other cross-sections for the support rods can also be realized.

According to a particularly preferred embodiment, the first support rod is welded in the first end area and the second support rod in the second end area. It is thereby advantageously possible to use materials which are optimized in terms of electron emission, thermal stability and elasticity for the two support rods on the one hand and for the emitter surface on the other.

A further preferred embodiment is characterized in that the first support rod is connected to the first end area and the second support rod in the second end area by way of hard soldering. In the case of this embodiment too, which represents an alternative to a welded connection, an optimum selection of material for the two support rods and for the emitter surface is advantageously possible.

According to a further advantageous embodiment, the emitter surface, the first support rod and the second support rod are embodied in one piece in an advantageous manner from the production technology perspective.

In the case of at least one embodiment of the inventive flat emitter, a separate heating current feed is possible. In this case the first support rod and the second support rod have an exclusively mechanical function. According to preferred embodiments, it is however possible that the first support rod is embodied as an electrical contact and/or the second support rod as an electrical contact. The first support rod and/or the second support rod thereby assume not only the mechanical function (fixing in the cathode) but also an electrical function (supplying of the heating current).

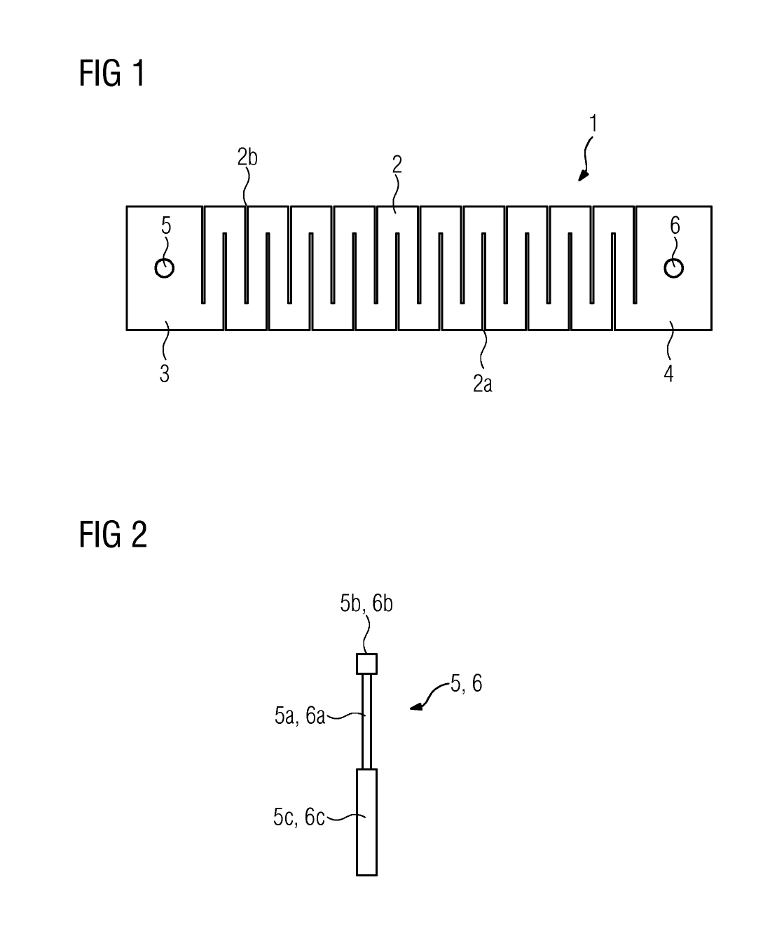

A flat emitter identified as 1 in FIG. 1 comprises an emitter surface 2 embodied in rectangular form, which emits electrons upon the application of a heating voltage.

The emitter surface 2 has indentations 2a and 2b, which are arranged emanating alternately from two opposite sites and across the longitudinal direction, and parallel to each other.

The emitter surface 2 need not necessarily be embodied in rectangular form in order to realize at least one embodiment of the invention. Rather, oval or circular emitter surfaces are for example suitable, which then, for example, have serpentine indentations.

The flat emitter 1 has on one side of the emitter surface 2 a first end area 3 and on the other side a second end area 4.

In the first end area 3 is arranged a first support rod 5 and in the second end area 4 a second support rod 6. In the example embodiment shown, the support rods 5 and 6 are fixed in the first end area 3 or second end area 4 respectively, for example by way of a welded connection (e.g. laser welding). As an alternative to a welded connection, the first support rod 5 and the second support rod 6 can also be connected to the first end area 3 or the second end area 4 respectively by way of hard soldering. Suitable soldering techniques for this purpose include, for example, laser soldering, MIG soldering (metal inert gas), TIG soldering (tungsten inert gas) and electron beam soldering. In the case of both welding-based bonding and hard soldering-based bonding, attention must be paid to an adequate temperature stability of the connection thus created.

As can be seen from FIG. 2, the first support rod 5 according to an embodiment of the invention has a narrow section 5a extending in a longitudinal direction. The second support rod 6, which is embodied in an identical manner to the first support rod 5, likewise has a narrow section 6a extending in a longitudinal direction. In both cases a head 5b or 6b respectively is thereby formed above the narrow section 5a or 6a respectively, and a foot part 5c or 6c respectively below the narrow section 7 or 8 respectively.

The bonded connection (welded connection, hard solder connection) between the first end area 3 and the first support rod 5 takes place via the head 5a. The second support rod 6 is connected to the second end area 4 in a similar manner via the head 6a.

The foot part 5c of the first support rod 5 and the foot part 6c of the second support rods 6 likewise serve in each case in each case to fix the flat emitter 1 in a cathode.

In the example embodiment shown, the first support rod 5 and the second support rod 6 assume not just the mechanical function (fixing in the cathode) but also the electrical function (supplying of the heating current).

By way of the narrow sections 5a and 6a, the spring constants of the support rods 5 and 6 are in each case reduced. The narrow sections 5a and 6a are not limited to the variant shown in FIG. 2. Rather, within the framework of an embodiment of the invention other embodiments of the narrow sections 5a and 6a can also be realized. A multiplicity of identically or differently embodied narrow sections can also be employed as advantageous embodiments.

The first or second support rod, 5 or 6 respectively, as shown in FIG. 2, in each case has a circular cross-section. Within the framework of an embodiment of the invention, other cross-sections, e.g. n-angular (rectangular, square, triangular) or oval forms can however also be realized for the support rods 5 and 6. If required, a cross-section which changes its geometric form, for example from circular to oval, can be realized for certain mechanical and/or thermal circumstances.

As the support rods 5 and 6 have reduced spring constants, then compared with solid, static support rods they exert less stress on the expanding flat emitter 1, so that the heated flat emitter 1 is afforded a certain freedom of movement in its thermally-related expansion. Fissures in the emitter structure, which reduce the useful life of the flat emitter 1, are thereby significantly diminished.

Although the invention is illustrated and described in a closer and more detailed manner by way of the preferred example embodiment, the invention is not limited by the example embodiment shown in the drawing. Rather the person skilled in the art can also derive other variants from the inventive solution, without hereby departing from the underlying idea of the invention.

As is evident from the description of the example embodiment shown, compared with solutions hitherto known, the inventive solution offers a flat emitter of structurally simpler design, providing a high level of electron emission at the same time as longer useful life.

1. A flat emitter, comprising:
an emitter surface, which upon application of a heating voltage, is configured to emit electrons;
a first end area including a first support rod; and
a second end area including a second support rod, at least one of the respective first and second support rods including a narrow section extending in a longitudinal direction and being bonded to a respective one of the first and second end areas.

2. The flat emitter of claim 1, wherein the first support rod and the second support rod each respectively include a narrow section extending in a longitudinal direction.

3. The flat emitter of claim 1, wherein the first support rod and the second support rod each respectively include a circular cross-section.

4. The flat emitter of claim 1, wherein the first support rod and the second support rod each respectively include a rectangular cross-section.

5. The flat emitter of claim 1, wherein the first support rod is welded in the first end area and the second support rod is welded in the second end area.

6. The flat emitter of claim 1, wherein, by way of hard soldering, the first support rod is connected in the first end area and the second support rod is connected in the second end area.

7. The flat emitter of claim 1, wherein the emitter surface, the first support rod and the second support rod are embodied in one piece.

8. The flat emitter of claim 1, wherein the first support rod is embodied as an electrical contact.

9. The flat emitter as claimed in claim 1, wherein the second support rod is embodied as an electrical contact.

10. A flat emitter, comprising:
an emitter surface, which upon application of a heating voltage, is configured to emit electrons;
a first end area including a first support rod; and
a second end area including a second support rod, the first support rod including a narrow section extending in a longitudinal direction and being bonded to the first end area.

11. The flat emitter of claim 10, wherein the emitter surface, the first support rod and the second support rod are embodied in one piece.

12. The flat emitter of claim 10, wherein the first support rod is embodied as an electrical contact.

13. A flat emitter, comprising:
an emitter surface, which upon application of a heating voltage, is configured to emit electrons;
a first end area including a first support rod; and
a second end area including a second support rod, the second support rod including a narrow section extending in a longitudinal direction and being bonded to the second end area.

14. The flat emitter of claim 13, wherein the emitter surface, the first support rod and the second support rod are embodied in one piece.

15. The flat emitter of claim 13, wherein the second support rod is embodied as an electrical contact.
